(19) United States
(12) Patent Application Publication
(10) Pub. No.: US 2026/0209421 A1
(43) Pub. Date: Jul. 23, 2026

(54) DEMULSIFIER COMPOSITIONS COMPRISING COPOLYMERS, METHODS OF PRODUCING AND USING THE SAME

(71) Applicant: Saudi Arabian Oil Company, Dhahran (SA)

(72) Inventor: Mohammed Alabuallirat, Al Qatif (SA)

(21) Appl. No.: 19/033,091

(22) Filed: Jan. 21, 2025

(51) Int. Cl. C08F 293/00; B01D 17/04; C02F 1/68; C02F 101/32

(52) U.S. Cl. CPC C08F 293/005; B01D 17/047; C02F 1/68; C02F 2101/32; C08F 2438/01

(57) ABSTRACT

The present disclosure provides a demulsifier composition. The demulsifier composition includes a solvent and a copolymer. The copolymer includes a hydrophobic polymer block derived from at least one hydrophobic monomer, wherein the hydrophobic monomer is selected from the group consisting of a hydrophobic aromatic monomer, a hydrophobic acrylate monomer, and combinations thereof. The copolymer includes a hydrophilic polymer block derived from at least one hydrophilic monomer, wherein the hydrophilic monomer is selected from the group consisting of a hydrophilic acrylate monomer, a hydrophilic acrylamide monomer, and combinations thereof. The copolymer includes a diblock copolymer comprising the hydrophobic polymer block and the hydrophilic polymer block, a statistical copolymer comprising the hydrophobic polymer block and the hydrophilic polymer block, or a triblock copolymer comprising one or more of the hydrophobic polymer block and one or more of the hydrophilic polymer block

### TECHNICAL FIELD

Embodiments of this disclosure generally relate to demulsifiers. More specifically, embodiments of this disclosure relate to a copolymer demulsifier and methods of producing the same.

### BACKGROUND

Crude oil emulsions form when crude oil comes into contact with water during extraction from the reservoir. Although crude oil and water are initially in separate phases, the turbulent flow in pipes and presence of surface-active substances that naturally occur in crude oil may cause the water and crude oil to form a stable emulsion. These emulsions are undesirable because the destruction and treatment of the emulsion adds to production cost and can cause loss of valuable amounts of crude oil. Demulsifiers may be used to disrupt the emulsion and to separate water from crude oil during the crude oil production process. Currently, demulsifiers are supplied to gas oil separation plants through vendors after conducting field trials of the selected demulsifier. These demulsifiers are prepared by mixing commodity chemicals and trial and error testing to obtain oil-water separation performance in crude oil emulsion. This method is costly because the raw materials are made without considering the specific type of crude being produced. This can cause the plant to use a lot of the material to produce on-spec crude, which is costly.

### SUMMARY

One technical problem associated with breaking crude oil emulsions using demulsifiers is that emulsion compositions vary between different reservoir locations. Therefore, commodity demulsifiers provided by vendors are seldom optimized for a specific reservoir location. Embodiments of the present disclosure include demulsifier compositions and methods of making and using the same that provide practical applications and technical advantages that address the aforementioned technical problems. In one embodiment, atom transfer radical polymerization (ATRP) is used to create block copolymers for a demulsifier composition. The provided method of using ATRP to create the block copolymers allows for precise control over the architecture of the block copolymers produced. The precise control may allow one to custom make the demulsifier based on properties of a certain crude oil emulsion. For example, the provided method of using ATRP to produce the block copolymers allows for customization of various parameters (e.g., a ratio of hydrophobic monomers to hydrophilic monomers, control over a hydrophilic block length, control over a hydrophilic block length, and the molecular weight of the block copolymer) to obtain demulsifier compositions that are tailored for a specific crude oil emulsion, thereby improving separation at the specific reservoir locations.

An embodiment of the present disclosure relates to a demulsifier composition. The demulsifier composition comprises a solvent and a copolymer. In some embodiments, the copolymer comprises a hydrophobic polymer block derived from at least one hydrophobic monomer, where the hydrophobic monomer is selected from the group consisting of a hydrophobic aromatic monomer, a hydrophobic acrylate monomer, and combinations thereof. In some embodiments, the copolymer comprises a hydrophilic polymer block derived from at least one hydrophilic monomer, where the at least one hydrophilic monomer is selected from the group consisting of a hydrophilic acrylate monomer, a hydrophilic acrylamide monomer, and combinations thereof. In some embodiments, the copolymer comprises a diblock copolymer comprising the hydrophobic polymer block and the hydrophilic polymer block, a statistical copolymer comprising the hydrophobic polymer block and the hydrophilic polymer block, or a triblock copolymer comprising one or more of the hydrophobic polymer block and one or more of the hydrophilic polymer block.

Another embodiment relates to a method for demulsifying a fluid. In some embodiments, the method includes adding a demulsifier composition to the fluid, where the fluid comprises a hydrocarbon phase and an aqueous phase, and where the demulsifier composition at least partially separates the hydrocarbon phase from the aqueous phase. In some embodiments, the demulsifier composition comprises a solvent and a copolymer. In some embodiments, the copolymer comprises a hydrophobic polymer block derived from at least one hydrophobic monomer, where the hydrophobic monomer is selected from the group consisting of a hydrophobic aromatic monomer, a hydrophobic acrylate monomer, and combinations thereof. In some embodiments, the copolymer comprises a hydrophilic polymer block derived from at least one hydrophilic monomer, where the at least one hydrophilic monomer is selected from the group consisting of a hydrophilic acrylate monomer, a hydrophilic acrylamide monomer, and combinations thereof. In some embodiments, the copolymer comprises a diblock copolymer comprising the hydrophobic polymer block and the hydrophilic polymer block, a statistical copolymer comprising the hydrophobic polymer block and the hydrophilic polymer block, or a triblock copolymer comprising one or more of the hydrophobic polymer block and one or more of the hydrophilic polymer block.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF THE DRAWINGS

FIG. 1 is a schematic drawing of a demulsifier composition according to an embodiment of the present disclosure.

FIG. 2 is a schematic drawing of a method of forming the demulsifier composition of FIG. 1 according to an embodiment of the present disclosure.

FIG. 3 is a method of forming the demulsifier composition of FIG. 1 an embodiment of the present disclosure.

FIG. 4 is a molar mass distribution of a first polymerized product according to an embodiment of the present disclosure.

FIG. 5 is a molar mass distribution of a diblock copolymer according to an embodiment of the present disclosure.

FIG. 6A is a Turbiscan scan illustrating changes in transmission over a 1 hour scan with 2-minutes interval of crude oil emulsion sample without additions (e.g., blank).

FIG. 6B is a Turbiscan scan illustrating changes in transmission over a 1 hour scan with 2-minutes interval of crude oil emulsion sample with 100 ppm incumbent demulsifier.

FIG. 6C is a Turbiscan scan illustrating a 1 hour scan with 2-minutes interval of crude oil emulsion sample with 100 ppm incumbent demulsifier plus 100 ppm of the synthesized block copolymer.

FIG. 7 is a photo after the test is done of the three samples tested (A) Blank crude oil emulsion, (B) crude oil emulsion+100 ppm incumbent demulsifier and (C) crude oil emulsion+100 ppm incumbent demulsifier+100 ppm block copolymer.

Like reference numbers and designations in the various drawings indicate like elements.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

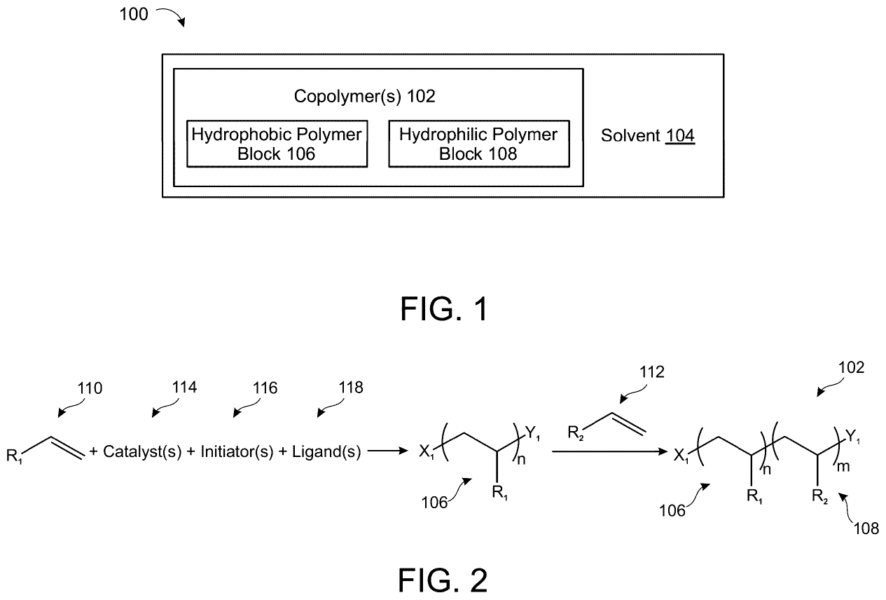

Referring to FIGS. 1-2, the present disclosure provides a demulsifier composition 100. In some embodiments, the demulsifier composition 100 comprises a copolymer 102 and a solvent 104. In some embodiments, the copolymer 102 comprises at least one hydrophobic polymer block 106 and at least one hydrophilic polymer block 108. In some embodiments, the hydrophobic block 106 is derived from at least one hydrophobic monomers 110, and the hydrophilic polymer block 108 is derived from at least one hydrophilic monomers 112. For example, the hydrophobic polymer block 106 may be formed by polymerizing the at least one hydrophobic monomers 110, and the hydrophilic polymer block 108 may be formed by polymerizing the at least one hydrophilic monomers 112. In some embodiments, the hydrophobic polymer block 106 and the hydrophilic polymer block 108 cause the copolymer 102 to be amphiphilic, where the copolymer 102 exhibits solubility in both an aqueous phase and an organic phase of a solution (e.g., crude oil and water mixture).

In some embodiments, the hydrophobic monomer 110 includes a hydrophobic aromatic monomer, a hydrophobic acrylate monomer, or combinations thereof. As used herein, the term “acrylate” includes acrylates, methacrylates, or a combination thereof. Suitable hydrophobic aromatic monomers may include, but are not limited to, styrene, vinyl toluene, alpha methyl styrene, or combinations thereof. Suitable hydrophobic acrylate monomers may include, but are not limited to, methyl methacrylate, methyl acrylate, ethyl n-butyl acrylate, pentyl acrylate, hexyl acrylate, 2-ethylhexyl acrylate, heptyl acrylate, octyl acrylate, nonyl acrylate, decyl acrylate, or combinations thereof.

In some embodiments, the at least one hydrophilic monomers 112 includes a hydrophilic acrylate monomer, a hydrophilic acrylamide monomer, or combinations thereof. For example, suitable hydrophilic acrylate monomers may include, but are not limited to, 2-hydroxy ethyl acrylate, acrylic acid, 2-hydroxy ethyl methacrylate, hydroxypropyl acrylate, 4-hydroxybutyl acrylate, or combinations thereof. Suitable hydrophilic acrylamide monomers may include, but are not limited to, N-hydroxyethylmethacrylamide, N-hydroxyethylacrylamide, N—N-dimethylacrylamide, N,N-dimethylmethacrylamide, or a combination thereof.

In some embodiments, the copolymer 102 has a structure according to the following Formula (I):

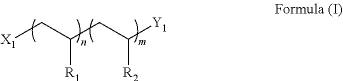

In some embodiments, the alkenyl group (e.g., C═C) in the hydrophobic monomer 110 forms the backbone of the hydrophobic polymer block 106 and R₁ comprises any one of the functional groups mentioned above for the hydrophobic monomer 110. In some embodiments, n is the number of polymerized hydrophobic monomers 110 in the hydrophobic polymer block 108. In some embodiments, n is an integer that ranges from about 10 to about 2000 polymerized hydrophobic monomers 110. In some embodiments, n is at least 10, or at least 20, or at least 30, or at least 40, or at least 50, or at least 100, to less than 200, or less than 300, or less than 400, or less than 500, or less than 1000, or less than 1500, or less than 2000.

In some embodiments, the alkenyl group in the hydrophilic monomer 112 forms the backbone of the hydrophilic polymer block 108 and R₂ comprises any one of the functional groups mentioned above for the hydrophilic monomer 112. In some embodiments, m is the is the number of polymerized hydrophilic monomers 112 in the hydrophilic polymer block 106. In some embodiments, n ranges from about 10 to about 2000 polymerized hydrophobic monomers 112. In some embodiments, n is at least 10, or at least 20, or at least 30, or at least 40, or at least 50, or at least 100, to less than 200, or less than 300, or less than 400, or less than 500, or less than 1000, or less than 1500, or less than 2000.

In some embodiments, X₁ is an initiator reaction product of an initiator 116 in an ATRP reaction. For example, during the ATRP reaction an organic halide (R—X₁), where R is a halide, is typically used as the initiator 116, where the halide is removed during the ATRP reaction and X₁ is coupled to either the hydrophobic monomer 110 or the hydrophilic monomer 112. For example, initiation may proceed via an electron transfer from the catalyst 114 (e.g., a transition metal catalyst, such as a copper-halide catalyst) to the halogen atom in the R—X_{I} bond, causing homolysis of the bond to yield R′ and an increase in the oxidation state of the catalyst 114 which captures the released halogen atom. Propagation of the chain radical is intercepted by the reverse process in which the oxidized transition metal complex donates a halogen atom of a new C—X bond at the chain end of either the hydrophilic polymer block 108 or the hydrophobic polymer block 106 and regeneration of the catalyst 114. The chain grows through a series of activation-propagation-deactivation cycles. Suitable initiators 114 include, but are not limited to, ethyl 2-bromoisobutyrate, 2-bromopropanitrile, ethyl 2-bromopropionate, methyl 2-bromopropionate, tosyl chloride, 1-cyano-1-methylethyldiethyldithiocarbamte, dimethnyl 2,6-dibromoheptanedioate, or combinations thereof. In some embodiments, X₁ is an initiator reaction product of an initiator 116 with a halogen atom removed.

In some embodiments, Y₁ is an end-group of the copolymer 102. While the copolymer 102 grows during the ATRP reaction, Y₁ may comprise a halogen atom. Following the ATRP reaction, the halogen atom of the copolymer 102 may be reacted off to incorporate end-group functionality to the copolymer 102. In some embodiments, Y₁ includes, but is not limited to, a halogen atom selected from bromine (e.g., —Br) or chlorine (e.g., —Cl).

In some embodiments, the copolymer 102 includes a diblock copolymer that comprises or consists of the hydrophobic polymer block 106 and the hydrophilic polymer block 108. In some embodiments, the diblock copolymer may comprise or consist of X₁-(hydrophobic polymer block)-(hydrophilic polymer block)-Y₁ or X₁-(hydrophilic polymer block)-(hydrophobic polymer block)-Y₁. In some embodiments, the copolymer 102 comprises a triblock copolymer that comprises or consists of one or more hydrophobic polymer block 106 and one or more hydrophilic polymer block 108. In some embodiments, the triblock copolymer may comprise or consist of X₁-(hydrophobic polymer block)-(hydrophilic polymer block)-(hydrophobic polymer block)-Y₁, X₁-(hydrophilic polymer block)-(hydrophobic polymer block)-(hydrophilic polymer block)-Y₁. In some embodiments, the copolymer 102 comprises a statistical copolymers comprising or consisting of the hydrophobic polymer block 106 and the hydrophilic polymer block 108. As used herein, “statistical copolymers” are copolymers in which the sequential distribution of the repeat units obey known statistical laws (e.g., Markovian).

Without wishing to be bound to any particular theory, it is contemplated herein that demulsifier compositions 100 with high molecular weight copolymers 102 (e.g., from about 15,000 g/mol to about 50,000 g/mol) may take longer to diffuse to an area with a high interfacial tension site (e.g., oi-water interface) but create an improved separation once they interact with the interface relative to low molecular weight copolymers 102 (e.g., from about 5,000 g/mol to 10,000 g/mol). On the other hand, low molecular weight copolymers 102 in the demulsifier composition 100 diffuse faster than high molecular weight copolymers 102 creating a fast oil-water separation. Different reservoir locations may benefit from a high molecular weight copolymer 102, and vis versa, depending on the composition of the oil-water mixture at the specific location.

In some embodiments, the copolymer 102 has a molecular weight from about 5,000 g/mol to about 50,000 g/mol. In some embodiments, the copolymer 102 is a low molecular weight copolymer 102 that has a molecular weight of at least about 5,000 g/mol, or at least about 5,500 g/mol, or at least about 6,000 g/mol, or at least about 6,500 g/mol, to less than about 7,000 g/mol, or less than about 7,500 g/mol, or less than about 8,000 g/mol, or less than about 8,500 g/mol, or less than about 9,000 g/mol, or less than 9,500 g/mol, or less than 10,000 g/mol. In some embodiments, the copolymer is a high molecular weight copolymer 102 that has a molecular weight of at least about 15,000 g/mol, or at least about 20,000, or at least about 25,000 g/mol, to less than about 30,000 g/mol, or less than about 35,000 g/mol, or less than about 40,000 g/mol, or less than about 45,000 g/mol, or less than about 50,000 g/mol.

In some embodiments, the copolymer 102 is present in the demulsifier composition 100 in an amount ranging from about 0.1 wt. % to about 60 wt. %, based on a total weight of the demulsifier composition 100. In some embodiments, the copolymer 102 is present in an amount from about 0.1 wt. %, or at least about 1 wt. %, or at least about 5 wt. %, or at least about 10 wt. %, or at least about 15 wt. %, or at least about 20 wt. %, or at least about 25 wt. %, or at least about 30 wt. %, or at least about 35 wt. %, to less than about 40 wt. %, or less than about 45 wt. %, or less than about 50 wt. %, or less than about 55 wt. %, or less than about 60 wt. %.

In some embodiments, the demulsifier composition 100 includes a solvent 104. In some embodiments, suitable solvents 104 include, but are not limited to, xylene, tetrahydrofuran, isopropanol, methanol, 2-ethylhexanol, benzene, toluene, or combinations thereof. In some embodiments, the solvent 104 is present in the demulsifier composition 100 in an amount ranging from about 30 wt. % to about 80 wt. %, based on a total weight of the demulsifier composition 100. In some embodiments, the solvent 104 is present in the demulsifier composition 100 in an amount of at least about 30 wt. %, or at least about 35 wt. %, or at least about 40 wt. %, or at least about 45 wt. %, or at least about 50 wt. %, to less than about 55 wt. %, or less than about 60 wt. %, or less than about 65 wt. %, or less than about 70 wt. %, or less than about 75 wt. %, or less than about 80 wt. %.

In some embodiments, the hydrophobic polymer block 106 is present in an amount ranging from about 10 to about 90 wt. % of the copolymer 102, based on a total weight of the copolymer 102. In some embodiments, the hydrophobic polymer block 106 is present in an amount ranging from at least about 10 wt. %, or at least about 20 wt. %, or at least about 30 wt. %, or at least about 40 wt. %, to less than 60 wt. %, or less than 70 wt. %, or less than 80 wt. %, or less than 90 wt. %, based on the total weight of the copolymer 102.

In some embodiments, the hydrophilic polymer block 108 is present in an amount ranging from about 10 to about 90 wt. % of the copolymer 102, based on a total weight of the copolymer 102. In some embodiments, the hydrophilic polymer block 108 is present in an amount ranging from at least about 10 wt. %, or at least about 20 wt. %, or at least about 30 wt. %, or at least about 40 wt. %, to less than 60 wt. %, or less than 70 wt. %, or less than 80 wt. %, or less than 90 wt. %, based on the total weight of the copolymer 102.

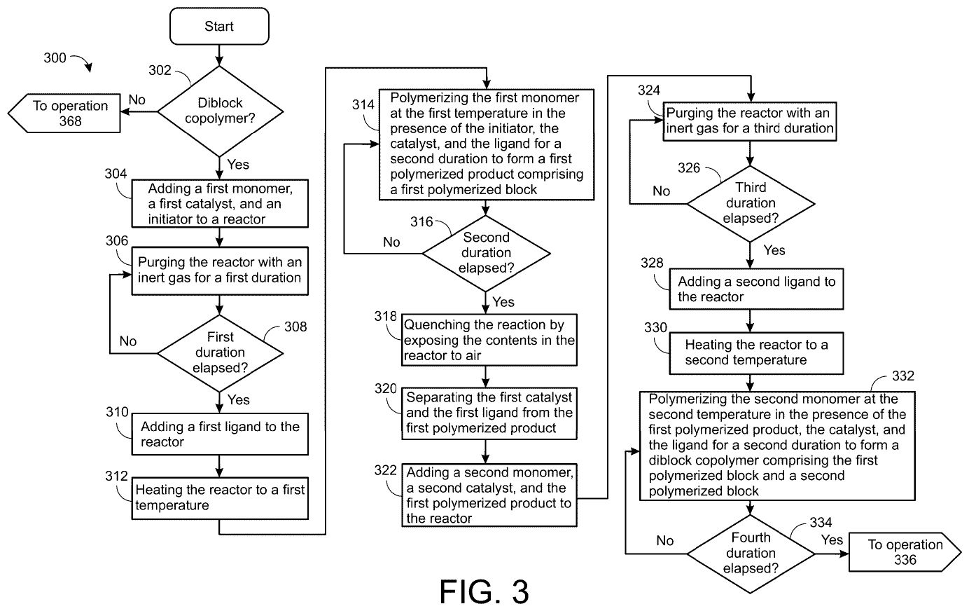

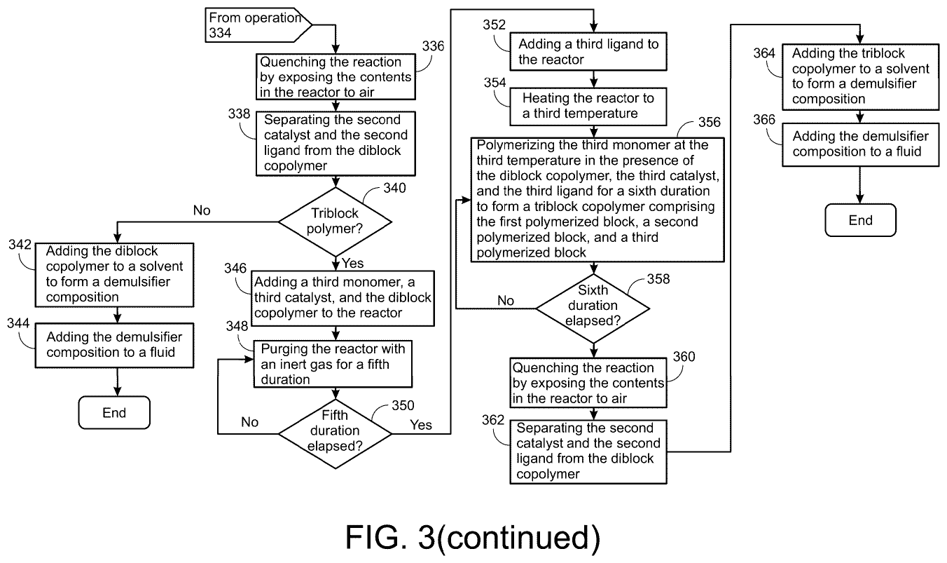

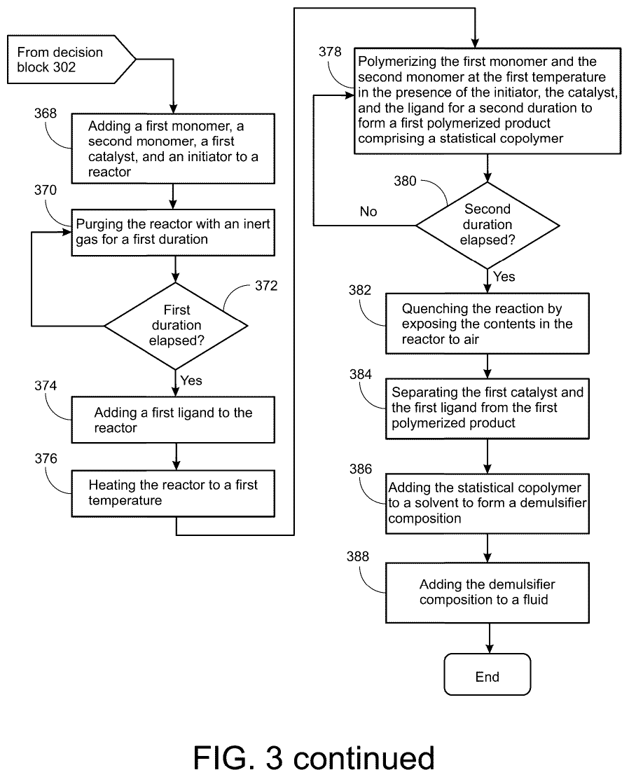

Referring to FIG. 3, a method 300 is provided for preparing a demulsifier composition 100 using ATRP. In some embodiments, the method 300 begins at decision block 302 where it is determined whether a diblock copolymer or a statistical copolymer should be synthesized. If it is determined that a diblock copolymer is desired, the method 300 proceeds to operation 304. In operation 304, the method 300 includes adding a first monomer (e.g., a hydrophobic monomer 110 or hydrophilic monomer 112), a first catalyst 114, and an initiator 116 to a reactor. At operation 306, the method 300 includes purging the reactor with an inert gas (e.g., nitrogen) for a first duration to reduce, or otherwise remove, oxygen from the reactor. At decision block 308, the method 300 includes determining if the first duration has elapsed. For example, the first duration may range from about 1 minute to about an hour. If the first duration has not elapsed, the method 300 returns to operation 306 for additional purging. If the first duration has elapsed, the method 300 proceeds to operation 310.

At operation 310, the method 300 includes adding the first ligand 118 to the reactor. In some embodiments, the ligand 118 coordinates to the catalyst 114, which facilitates activating it towards loss of an electron and atom transfer during the ATRP reaction. Suitable ligands 118 include, but are not limited to, pentamethyl diethylenetriamine, hexamethyltriethylenetetramine, tris(2-dimethylaminoethyl)amine, 2,2′-bipyridine, 4,4′,4″-tris(5-nonyl)-2,2′:6′,2″-terpyridine, N,N-bis(2-pyridylmethyl)octadecylamine, tetra[(2-pyridal)methyl]ethylenediamine, tris[(2-pyridyl)methyl]amine, tris(2-aminoethyl)amine, tris(2-bis(3-butoxy-3-oxopropyl)aminoethyl)amine, tris(2-bis(3-(2-ethylhexoxy)-3-oxopropyl)aminoethyl)amine, tris(2-bis(3-dodecoxy-3-oxopropyl)aminoethyl)amine, or combinations thereof.

At operation 312, the method 300 includes heating the reactor and contents therein to a first temperature. In some embodiments, operation 312 includes heating the reactor to a first temperature that ranges from about 75° C. to about 120° C. For example, operation 312 may include heating the reactor to a temperature of at least about 75° C., or at least about 80° C., or at least about 85° C., or at least about 90° C., or at least about 95° C., to less than 100° C., or less than 105° C., or less than 110° C., or less than 115° C., or less than 120° C.

At operation 314, the method 300 includes polymerizing the first monomer at the first temperature in the presence of the initiator 116, the first catalyst 114, and the first ligand 118 for a second duration to form a first polymerized product comprising a first polymerized block. In some embodiments, the second duration is at least about 10 minutes, at least about 30 minutes, at least about 1 hour, at least about 2 hours, at least about 3 hours, to less than 4 hours, or less than 5 hours.

At decision block 316, the method 300 includes determining whether the second duration has elapsed. If the second duration has not elapsed, the method 300 returns to operation 312 for additional polymerization. If the second duration has elapsed, the method 300 proceeds to operation 318. At operation 318, the method 300 includes quenching the reaction. In some embodiments, quenching the reaction includes exposing the first polymerized block within the reactor to air, and optionally removing the heat.

At operation 320, the method 300 includes separating the first catalyst 114 and the first ligand 118 from the first polymerized block. In some embodiments, separating the first catalyst 114 and the first ligand 118 from the first polymerized block includes passing the first polymerized block, the first catalyst 114, and the first ligand 118 through a packed column (e.g., aluminum column). In some embodiments, a solvent, such as tetrahydrofuran, may be used to pass the first catalyst 114 and the first ligand 118 through the packed column. Operation 320 may further include air drying the reaction mixture and then precipitating the first polymerized block in a polar solvent (e.g., menthol) to remove unreacted first monomers.

At operation 322, the method 300 includes adding a second monomer (e.g., a hydrophobic monomer 110 or a hydrophilic monomer 112), a second catalyst 114, and the first polymerized product to the reactor. At operation 324, the method 200 includes purging the reactor with an inert gas (e.g., nitrogen) for a third duration to reduce, or otherwise remove, oxygen from the reactor. At decision block 326, the method 300 includes determining if the third duration for purging has elapsed. For example, the third duration may range from 1 minute to an hour. If the third duration has not elapsed, the method 300 returns to operation 324 for additional purging. If the third duration has elapsed, the method 300 proceeds to operation 328, which includes adding the second ligand 118 to the reactor.

At operation 330, the method 300 includes heating the reactor and contents therein. In some embodiments, operation 330 includes heating the reactor to a temperature from about 75° C. to about 120° C. For example, operation 310 may include heating the reactor to a temperature of at least about 75° C., or at least about 80° C., or at least about 85° C., or at least about 90° C., or at least about 95° C., to less than 100° C., or less than 105° C., or less than 110° C., or less than 115° C., or less than 120° C.

At operation 332, the method 300 includes polymerizing the second monomer at the second temperature in the presence of the first polymerized product, the second catalyst 114, and the second ligand 118 for a fourth duration to form a diblock copolymer comprising the first polymerized block and a second polymerized block. In some embodiments, the fourth duration is at least about 10 minutes, at least about 30 minutes, at least about 1 hour, at least about 2 hours, at least about 3 hours, to less than 4 hours, or less than 5 hours.

At decision block 334, the method 300 includes determining whether the fourth duration has elapsed. If the fourth duration has elapsed, the method 300 proceeds to operation 336, which includes quenching the reaction by exposing the diblock polymer within the reactor to air, and optionally removing the heat.

At operation 338, the method 300 includes separating the second catalyst 114 and the second ligand 118 from the diblock copolymer. In some embodiments, separating the second catalyst and the second ligand 118 from the diblock copolymer includes passing the diblock copolymer, the second catalyst 114, and the second ligand through a packed column (e.g., aluminum column). In some embodiments, a solvent, such as tetrahydrofuran, may be used to transport the material through the packed column.

At decision block 340, the method 300 includes determining whether a triblock copolymer should be synthesized. If it is determined that a triblock copolymer should be not be synthesized, the method 300 proceeds to operation 342. At operation 342, the method 300 includes adding the diblock copolymer to a solvent to form the demulsifier composition 100. At operation 344, the method 300 includes adding the demulsifier composition 100 to a fluid. In some embodiments, the fluid is a crude oil emulsion that comprises a hydrocarbon phase and an aqueous phase. In some embodiments, the demulsifier composition 100 at least partially separates the hydrocarbon phase from the aqueous phase to break the emulsion in the fluid. In some embodiments, the hydrocarbon phase comprises crude oil, and the aqueous phase comprises water. The method 300 may end following operation 344.

Returning to decision block 340, if it is determined that a triblock copolymer should be synthesized, the method 300 proceeds to operation 346. At operation 346, the method includes adding a third monomer, a third catalyst 114, and the diblock copolymer to the reactor. At operation 348, the method 300 includes purging the reactor with an inert gas (e.g., nitrogen) for a fifth duration to reduce, or otherwise remove, oxygen from the reactor. At decision block 350, the method 300 includes determining if the fifth duration has elapsed. For example, the fifth duration may range from about 1 minute to about an hour. If the fifth duration has not elapsed, the method 300 returns to operation 348 for additional purging. If the fifth duration has elapsed, the method 300 proceeds to operation 352.

At operation 352, the method 300 includes adding a third ligand 118 to the reactor. At operation 354, the method 300 includes heating the reactor and contents therein to a third temperature. In some embodiments, operation 354 includes heating the reactor to a third temperature that ranges from about 75° C. to about 120° C. For example, operation 354 may include heating the reactor to a temperature of at least about 75° C., or at least about 80° C., or at least about 85° C., or at least about 90° C., or at least about 95° C., to less than 100° C., or less than 105° C., or less than 110° C., or less than 115° C., or less than 120° C.

At operation 356, the method 300 includes polymerizing the third monomer at the third temperature in the presence of the diblock copolymer, the third catalyst 114, and the third ligand 118 for a third duration to form the triblock copolymer comprising the first polymerized block, the second polymerized block and the third polymerized block. In some embodiments, the second duration is at least about 10 minutes, at least about 30 minutes, at least about 1 hour, at least about 2 hours, at least about 3 hours, to less than 4 hours, or less than 5 hours.

At operation 358, the method 300 includes determining whether the third duration has elapsed. If the third duration has not elapsed, the method 300 returns to operation 356 for additional polymerization. If the third duration has elapsed, the method 300 proceeds to operation 360. At operation 360, the method 300 includes quenching the reaction. In some embodiments, quenching the reaction includes exposing the triblock copolymer within the reactor to air, and optionally removing the heat.

At operation 362, the method 300 includes separating the third catalyst 114 and the third ligand 118 from the triblock copolymer. In some embodiments, separating the third catalyst 114 and the third ligand 118 from the triblock copolymer includes passing the triblock copolymer, the third catalyst 114, and the third ligand 118 through a packed column (e.g., aluminum column). In some embodiments, a solvent, such as tetrahydrofuran, may be used to pass the contents through the packed column.

At operation 364, the method 300 includes adding the triblock copolymer to a solvent to form the demulsifier composition 100. At operation 366, the method 300 includes adding the demulsifier composition 100 to a fluid. In some embodiments, the fluid is a crude oil emulsion that comprises a hydrocarbon phase and an aqueous phase. In some embodiments, the demulsifier composition 100 at least partially separates the hydrocarbon phase from the aqueous phase to break the emulsion in the fluid. In some embodiments, the hydrocarbon phase comprises crude oil, and the aqueous phase comprises water. The method 300 may end following operation 366.

Returning to decision block 302 where it is determined whether a diblock copolymer or a statistical copolymer should be synthesized, if it is determined that a statistical copolymer should be synthesized, the method 300 proceeds to operation 368. At operation 368, the method 300 includes adding a first monomer (e.g., a hydrophobic monomer 110) and a second monomer (hydrophilic monomer 112), a first catalyst 114, and an initiator 116 to a reactor. At operation 370, the method 300 includes purging the reactor with an inert gas (e.g., nitrogen) for a first duration to reduce, or otherwise remove, oxygen from the reactor. At decision block 372, the method 300 includes determining if the first duration has elapsed. For example, the first duration may range from about 1 minute to about an hour. If the first duration has not elapsed, the method 300 returns to operation 370 for additional purging. If the first duration has elapsed, the method 300 proceeds to operation 372.

At operation 374, the method 300 includes adding the first ligand 118 to the reactor. At operation 376, the method 300 includes heating the reactor and contents therein to a first temperature. In some embodiments, operation 376 includes heating the reactor to a first temperature that ranges from about 75° C. to about 120° C. For example, operation 312 may include heating the reactor to a temperature of at least about 75° C., or at least about 80° C., or at least about 85° C., or at least about 90° C., or at least about 95° C., to less than 100° C., or less than 105° C., or less than 110° C., or less than 115° C., or less than 120° C.

At operation 378, the method 300 includes polymerizing the first monomer and the second monomer at the first temperature in the presence of the initiator 116, the first catalyst 114, and the first ligand 118 for a second duration to form a first polymerized product comprising a statistical copolymer. In some embodiments, the second duration is at least about 10 minutes, at least about 30 minutes, at least about 1 hour, at least about 2 hours, at least about 3 hours, to less than 4 hours, or less than 5 hours.

At decision block 380, the method 300 includes determining whether the second duration has elapsed. If the second duration has not elapsed, the method 300 returns to operation 312 for additional polymerization. If the second duration has elapsed, the method 300 proceeds to operation 382. At operation 382, the method 300 includes quenching the reaction. In some embodiments, quenching the reaction includes exposing the statistical copolymer within the reactor to air, and optionally removing the heat.

At operation 384, the method 300 includes separating the first catalyst 114 and the first ligand 118 from the statistical copolymer. In some embodiments, separating the first catalyst 114 and the first ligand 118 from the statistical copolymer includes passing the statistical copolymer, the first catalyst 114, and the first ligand 118 through a packed column (e.g., aluminum column). In some embodiments, a solvent, such as tetrahydrofuran, may be used to pass the contents through the packed column.

At operation 386, the method 300 includes adding the statistical copolymer to a solvent to form the demulsifier composition 100. At operation 388, the method 300 includes adding the demulsifier composition 100 to a fluid. In some embodiments, the fluid is a crude oil emulsion that comprises a hydrocarbon phase and an aqueous phase. In some embodiments, the demulsifier composition 100 at least partially separates the hydrocarbon phase from the aqueous phase to break the emulsion in the fluid. In some embodiments, the hydrocarbon phase comprises crude oil, and the aqueous phase comprises water. The method 300 may end following operation 388.

### EXAMPLES

### Example 1—Block Copolymer Comprising Polystyrene and Poly(2-Hydroxy Ethyl Acrylate)

A block copolymer containing polystyrene as the first hydrophobic polymeric block and 2-hydroxy ethyl acrylate as the second hydrophilic polymeric block was synthesized using ATRP. Because demulsifiers may consist of multiple components, the resulting surfactant was added to an existing demulsifier to evaluate its performance for oil in water reduction and increased water clarity.

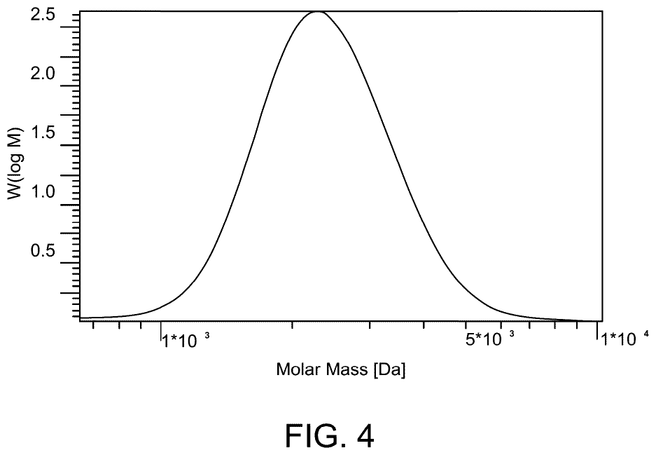

The first block was synthesized using ATRP. In a Schlenk tube equipped with a stir bar, ethyl 2-bromo-2-methylpropionate (75 μL), styrene (30 mL), CuBr (70 mg) were added. Following 20 minutes of nitrogen purging, PMDETA ligand (0.11 mL) was rapidly injected. The Schelnk tube was then immersed in a 90° C. oil bath. The reaction proceeded at 90° C. for 3 hours and then, it was stopped by exposing the Schlenk tube contents to air. The resulting polymer was checked by GPC and found to have weight average molecular weight of 2200 g/mol with a PDI of 1.1. The polymer was purified by passing it through alumina after adding THF to remove the copper catalyst. The reaction mixture was air dried and then precipitated in methanol to remove excess unreacted styrene. The molar mass distribution of the polystyrene is shown in FIG. 4.

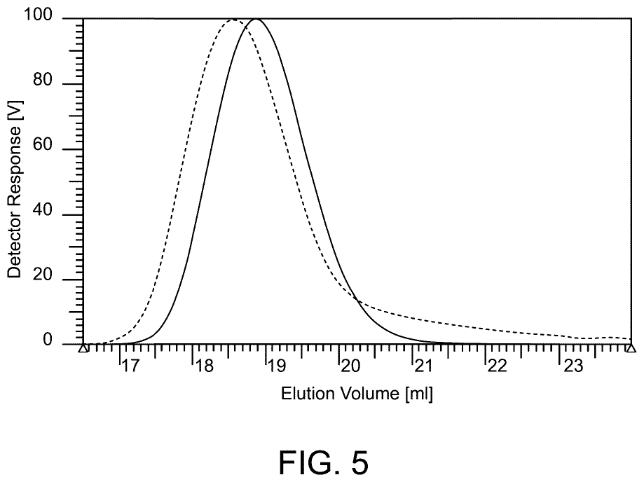

The second block was synthesized using ATRP for chain extension. In a Schlenk tube equipped with a stir bar, polystyrene (510 mg), 2-hydroxy ethyl acrylate (0.6 mL), CuBr (33 mg) and THF (10 mL) were added. Following 20 minutes of nitrogen purging, PMDETA ligand (0.1 mL) was rapidly injected. The Schlenk tube was then immersed in an 80° C. oil bath. The reaction proceeded at 80° C. for 15 hours and then, it was stopped by exposing the Schlenk tube contents to air. The resulting polymer was checked by GPC and was found to reach weight average molecular weight of 4500 g/mol with a PDI of 1.32. The reaction mixture was passed through alumina to remove the copper catalyst and used as 10% demulsifier in THF. The molar mass distribution of the block copolymer polystyrene-b-poly(2-hydroxy ethyl acrylate) is shown in FIG. 5.

Turbiscan scans use transmission which involves measuring the amount of light that passes through the sample. Changes in transmission can indicate variations in the sample's homogeneity, such as separation or water clarification, providing information about the stability and distribution of the dispersed phases. The horizontal data indicates the vertical scan of the vial from bottom to the top. As time passes, the transmission increases as the light passes through the water separated until it reaches the crude oil where it goes completely to 0% transmission. Those scans are accumulated as they have an interval of 2 minutes per scan where the blue color represent the initial scans and red color represent the final scans.

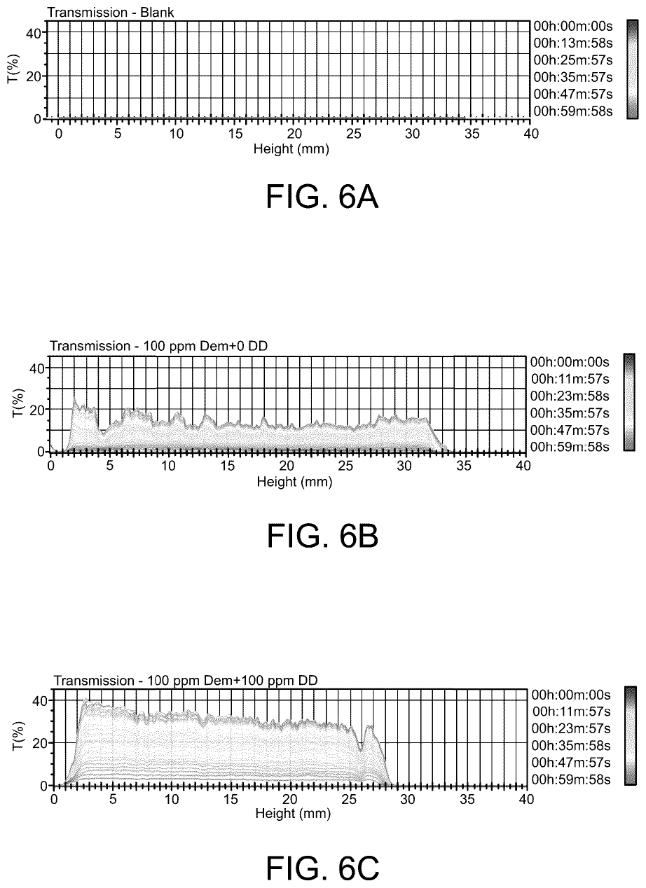

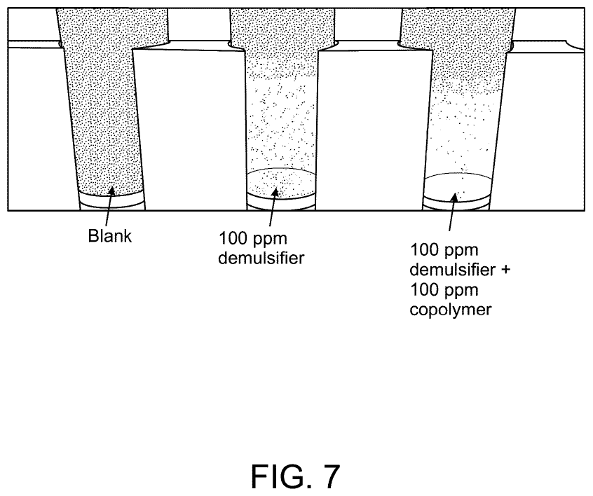

FIG. 6A shows a 1 hour scan with 2-minutes interval of crude oil emulsion sample without additions (Blank). FIG. 6B shows a 1 hour scan with 2-minutes interval of crude oil emulsion sample with 100 ppm incumbent demulsifier. FIG. 6C shows a 1 hour scan with 2-minutes interval of crude oil emulsion sample with 100 ppm incumbent demulsifier plus 100 ppm of the synthesized block copolymer. FIG. 7 shows a photo after the test is done of the three samples tested (A) Blank crude oil emulsion, (B) crude oil emulsion+100 ppm incumbent demulsifier and (C) crude oil emulsion+100 ppm incumbent demulsifier+100 ppm block copolymer.

What is claimed is:

1. A demulsifier composition comprising:
a solvent; and
a copolymer comprising:
a hydrophobic polymer block derived from at least one hydrophobic monomer, wherein the hydrophobic monomer is selected from the group consisting of a hydrophobic aromatic monomer, a hydrophobic acrylate monomer, and combinations thereof;
a hydrophilic polymer block derived from at least one hydrophilic monomer, wherein the hydrophilic monomer is selected from the group consisting of a hydrophilic acrylate monomer, a hydrophilic acrylamide monomer, and combinations thereof; and
wherein the copolymer comprises a diblock copolymer comprising the hydrophobic polymer block and the hydrophilic polymer block, a statistical copolymer comprising the hydrophobic polymer block and the hydrophilic polymer block, or a triblock copolymer comprising one or more of the hydrophobic polymer block and one or more of the hydrophilic polymer block.

2. The demulsifier composition of claim 1, wherein the hydrophobic aromatic monomer comprises styrene.

3. The demulsifier composition of claim 1, wherein the hydrophilic acrylate monomer is selected from the group consisting of: 2-hydroxy ethyl acrylate, acrylic acid, and combinations thereof.

4. The demulsifier composition of claim 1, wherein the hydrophobic acrylate monomer is selected from the group consisting of: methyl methacrylate, n-butyl acrylate, and combinations thereof.

5. The demulsifier composition of claim 1, wherein the copolymer is present in an amount ranging from about 0.1 to about 60 wt % of the demulsifier composition, based on a total weight of the demulsifier composition; and
wherein the solvent is present in an amount ranging from about 30 to about 80 wt % of the demulsifier composition, based on the total weight of the demulsifier composition.

6. The demulsifier composition of claim 1, wherein the copolymer has a molecular weight from about 5,000 to about 50,000 g/mol.

7. The demlusifier composition of claim 1, wherein the copolymer has a molecular weight from about 5,000 to about 10,000 g/mol.

8. The demulsifier composition of claim 1, wherein the copolymer has a molecular weight from about 15,000 to about 50,000 g/mol.

9. The demulsifier composition of claim 1, wherein the hydrophobic polymer block is present in an amount ranging from about 10 to about 90 wt % of the copolymer, based on the total weight of the copolymer.

10. A method for demulsifying a fluid, the method comprising:
adding a demulsifier composition to the fluid, wherein the fluid comprises a hydrocarbon phase and an aqueous phase, wherein the demulsifier composition at least partially separates the hydrocarbon phase from the aqueous phase; and
wherein the demulsifier composition comprises:
a solvent;
a copolymer comprising:
a hydrophobic polymer block derived from at least one hydrophobic monomer, wherein the hydrophobic monomer is selected from the group consisting of: a hydrophobic aromatic monomer, a hydrophobic acrylate monomer, and combinations thereof;
a hydrophilic polymer block derived from at least one hydrophilic monomer, wherein the hydrophilic monomer is selected from the group consisting of: a hydrophilic acrylate monomer, a hydrophilic acrylamide monomer, and combinations thereof; and
wherein the copolymer comprises a diblock copolymer comprising the hydrophobic polymer block and the hydrophilic polymer block, a statistical copolymer comprising the hydrophobic polymer block and the hydrophilic polymer block, or a triblock copolymer comprising one or more of the hydrophobic polymer block and one or more of the hydrophilic polymer block.

11. The method of claim 10, wherein the hydrocarbon phase comprises crude oil.

12. A method for preparing a demulsifier composition using atom transfer radical polymerization, the method comprising:
polymerizing a first monomer in the presence of an initiator, one or more catalysts, and one or more ligands to form a first polymerized product comprising the first monomer;
polymerizing a second monomer in the presence of the first polymerized product, the one or more catalysts, and the one or more ligands to generate a copolymer, wherein the copolymer comprises a diblock copolymer comprising a hydrophobic polymer block and a hydrophilic polymer block or a statistical copolymer comprising the hydrophobic polymer block and the hydrophilic polymer block, wherein:
the hydrophobic block comprises a hydrophobic monomer, wherein the hydrophobic monomer is selected from the group consisting of a hydrophobic aromatic monomer, a hydrophobic acrylate monomer, and combinations thereof;
wherein the hydrophilic block comprises a hydrophilic monomer, wherein the hydrophilic monomer is selected from the group consisting of a hydrophilic acrylate monomer, a hydrophilic acrylamide monomer, and combinations thereof; and
forming a demulsifier composition by adding the copolymer to a solvent.

13. The method of claim 12, wherein generating the diblock copolymer comprises:
polymerizing the first monomer in the presence of the initiator, a first catalyst, and a first ligand to form the first polymerized product comprising the first monomer, wherein the first polymerized product comprises a first polymerized block;
separating the first catalyst and the first ligand from the first polymerized block;
polymerizing the second monomer in the presence of the first polymerized block, a second catalyst, and a second ligand to form the diblock copolymer;
separating the second catalyst and the second ligand from the diblock copolymer; and
forming the demulsifier composition by adding the diblock copolymer to the solvent.

14. The method of claim 13, wherein polymerizing the first monomer further comprises:
purging a reactor comprising the first monomer, the initiator, and the first catalyst with an inert gas for a first duration; and after the first duration elapses, the method further comprises:
adding the first ligand; and
heating the reactor for a second duration to form the first polymerized block, and after the second duration elapses, the method further comprises:
quenching the reaction by exposing the first polymerized block to oxygen.

15. The method of claim 13, wherein separating the first catalyst and the first ligand from the first polymerized block further comprises passing the first polymerized block, the first catalyst, and the first ligand through a packed column.

16. The method of claim 12, further comprising:
polymerizing the first monomer in the presence of the initiator, a first catalyst, and a first ligand to form the first polymerized product, wherein the first polymerized product comprises a first polymerized block;
separating the first catalyst and the first ligand from the first polymerized block;
polymerizing the second monomer in the presence of the first polymerized block, a second catalyst, and a second ligand to form the diblock copolymer;
separating the second catalyst and the second ligand from the diblock copolymer;
polymerizing a third monomer in the presence of the diblock copolymer, a third catalyst, and a third ligand to form a triblock copolymer comprising the hydrophobic block and the hydrophilic block;
separating the third catalyst and the third ligand from the triblock copolymer; and
forming the demulsifier by adding the triblock copolymer to the solvent.

17. The method of claim 12, further comprising:
polymerizing the first monomer and the second monomer in the presence of the initiator, a first catalyst, and a first ligand to form the statistical copolymer;
separating the first catalyst and the first ligand from the statistical copolymer; and
forming the demulsifier by adding the statistical copolymer to the solvent.

18. The method of claim 12, wherein the initiator is selected from the group consisting of ethyl 2-bromoisobutyrate, 2-bromopropanitrile, ethyl 2-bromopropionate, methyl 2-bromopropionate, tosyl chloride, 1-cyano-1-methylethyldiethyldithiocarbamte, 2-(N,N-diethyldithiocarbamyl)-isobutyric acid ethyl ester, dimethnyl 2,6-dibromoheptanedioate, or combinations thereof.

19. The method of claim 12, wherein the one or more catalyst comprises a transition metal catalyst.

20. The method of claim 12, wherein the transition metal catalyst comprises a copper-halide catalyst.

21. The method of claim 12, wherein the one or more ligand is selected from the group consisting of pentamethyl diethylenetriamine, hexamethyltriethylenetetramine, tris(2-dimethylaminoethyl)amine, 2,2′-bipyridine, 4,4′,4″-tris(5-nonyl)-2,2′:6′,2″-terpyridine, N,N-bis(2-pyridylmethyl)octadecylamine, tetra[(2-pyridal)methyl]ethylenediamine, tris[(2-pyridyl)methyl]amine, tris(2-aminoethyl)amine, tris(2-bis(3-butoxy-3-oxopropyl)aminoethyl)amine, tris(2-bis(3-(2-ethylhexoxy)-3-oxopropyl)aminoethyl)amine, tris(2-bis(3-dodecoxy-3-oxopropyl)aminoethyl)amine, or combinations thereof.
